(19) United States
(12) Patent Application Publication
(10) Pub. No.: US 2008/0059161 A1
(43) Pub. Date: Mar. 6, 2008

(54) Adaptive Comfort Noise Generation

(75) Inventors: Hosam A. Khalil, Redmond, WA (US); Tian Wang, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/470,577

(22) Filed: Sep. 6, 2006

(51) Int. Cl. G10L 21/02

(52) U.S. Cl. 704/226

(57) ABSTRACT

This document describes tools capable of enabling and/or adaptively generating comfort noise. The tools may do so by receiving some background noise, analyzing that noise, and generating comfort noise based on the received background noise. In some embodiments, for example, the tools build and continuously adapt a history based on segments of background noise as they are received from the sender. The tools may use this history to generate comfort noise that is pleasing, relatively accurate, and/or dynamically changing responsive to changes in a speaker's background noise.

### BACKGROUND

More and more people are talking over digital communication networks, such as one-to-one or in structured conferences. This type of communication is often made following Voice-over-Internet Protocol (VoIP). With VoIP, an audio signal from one person is converted from its original analog format to a digital format and sent in data packets over the network to a receiving person's computer. Once received, the data packets are converted back into an analog format and rendered so that the receiving person can hear the sending person's audio.

One drawback of VoIP and similar protocols, however, is that sending audio over a communication network uses a significant amount of bandwidth. To reduce the bandwidth needed, many current techniques take advantage of the fact that a speaker's audio signal often does not contain speech. People typically do not speak constantly—there are breaks while a person pauses to listen or takes a breath. When a person stops speaking, the audio signal usually contains background noise but not speech. To use less bandwidth, some of these techniques send the background noise but at reduced fidelity; some forgo sending data packets of background noise at all; and some send information about the background noise rather than background noise itself. Each of these techniques has flaws.

The first-mentioned technique—that of sending background noise but at reduced fidelity—still uses significant bandwidth. The data packets are still sent but with smaller data loads in each packet. But each packet has significant overhead based on headers and other information commonly sent with packets regardless of the size of the data load. Consequently, the bandwidth savings can be quite small.

In the other techniques—those of not sending the background noise at all or sending just information about it—the receiver's computing device may generate synthetic noise (called “comfort noise”) so that the receiving person does not hear blank space. Blank space often makes people uncomfortable because they feel disconnected. Current comfort noise generation, however, often fails to provide a pleasing, dynamic, or accurate approximation of the real background noise.

### SUMMARY

This document describes tools capable of enabling and/or adaptively generating comfort noise. The tools may do so by receiving some background noise, analyzing that noise, and generating comfort noise based on the received background noise. In some embodiments, for example, the tools build and continuously adapt a history based on segments of background noise as they are received from the sender. The tools may use this history to generate comfort noise that is pleasing, relatively accurate, and/or dynamically changing responsive to changes in a speaker's background noise.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “tools,” for instance, may refer to system(s), method(s), computer-readable instructions, and/or technique(s) as permitted by the context above and throughout the document.

### BRIEF DESCRIPTION OF THE DRAWINGS

FIG. 1 illustrates an exemplary operating environment in which various embodiments of the tools may operate.

FIG. 2 illustrates an exemplary audio signal having talk spurts and background noise.

FIG. 3 illustrates an exemplary central communication topology.

FIG. 4 illustrates an exemplary distributed communication topology.

FIG. 5 illustrates the audio signal of FIG. 2 but showing two talk-and-noise portions of the audio signal that are sent over a communication network.

FIG. 6 is a flow diagram showing receipt of packets over a network and exemplary actions of an adaptive history module determining if frames of the packets represent background noise.

FIG. 7 is an exemplary process showing actions of a voice handler in response to receiving or not receiving packets.

FIG. 8 is a flow diagram showing exemplary ways in which the comfort noise generator generates comfort noise.

FIG. 9 illustrates an exemplary frequency spectrum of an exemplary frequency template having a frequency peak reduced over time.

FIG. 10 illustrates the audio signal of FIG. 5, which is received by the speaker's communication device, and an audio signal rendered to a listener, the rendered signal having comfort noise in place of some of the background noise of the audio signal.

FIG. 11 is an exemplary process describing various ways in which the tools may act to enable and generate comfort noise.

The same numbers are used throughout the disclosure and figures to reference like components and features

### DETAILED DESCRIPTION

### Overview

The following document describes tools capable of enabling and/or generating comfort noise for voice communications over a network. The tools may adapt to changes in a speaker's background noise effective to generate comfort noise that also adapts to these changes. The tools may do so at significant bandwidth savings over some other techniques.

An environment in which the tools may enable these and other techniques is set forth first below in a section entitled Exemplary Operating Environment. This section is followed by another section describing exemplary manners in which elements of the exemplary operating environment may build and adapt a noise history, entitled Building and Adapting an Exemplary Noise History. Another section follows, which describes exemplary manners in which elements of the exemplary operating environment may use this history to generate comfort noise, entitled Adaptively Generating Comfort Noise. A final section, entitled Additional Embodiments, sets forth various ways in which the tools may act to enable and generate comfort noise.

### Exemplary Operating Environment

Before describing the tools in detail, the following discussion of an exemplary operating environment is provided to assist the reader in understanding some ways in which various inventive aspects of the tools may be employed. The environment described below constitutes but one example and is not intended to limit application of the tools to any one particular operating environment. Other environments may be used without departing from the spirit and scope of the claimed subject matter.

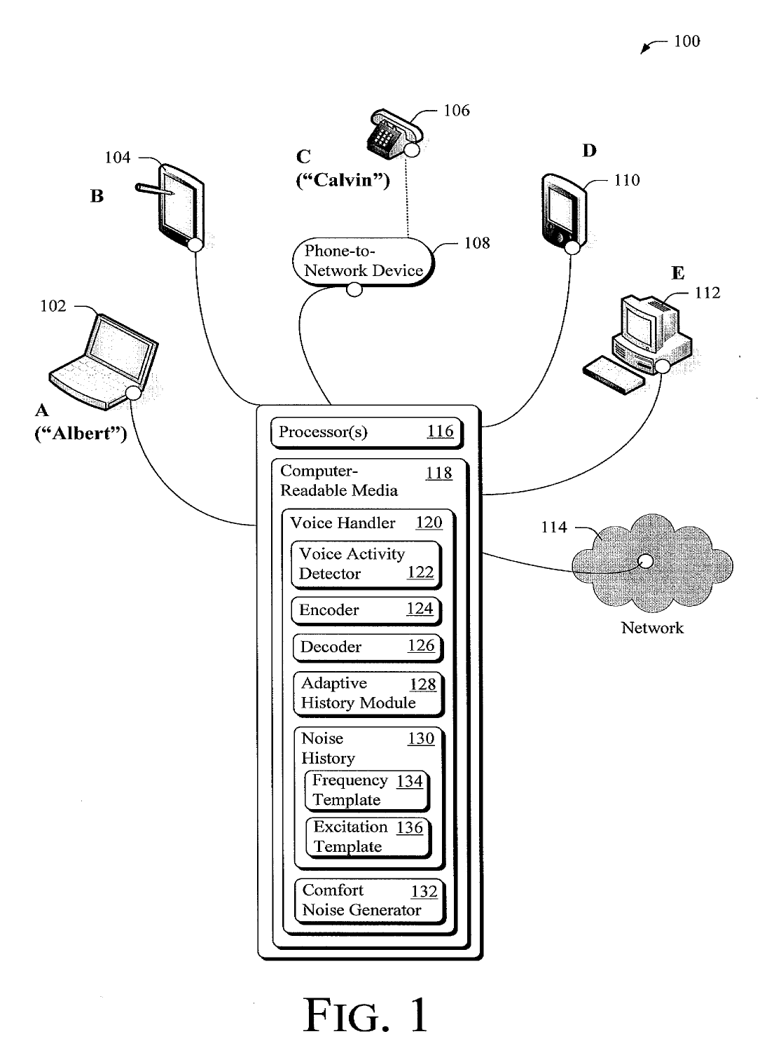

FIG. 1 illustrates one such operating environment generally at 100 having five speakers/listeners (“participants”), participant A (“Albert”) shown communicating with a communication device 102, participant B shown communicating with a communication device 104, participant C (“Calvin”) shown communicating with a telephone 106 connected to a phone-to-network communication device 108, participant D shown communicating with a communication device 110, and participant E shown communicating with a communication device 112. A participant may, in some cases, contain multiple persons—such as when two people are speaking on telephone 106 either over a speaker phone or a telephone-network-enabled conference call. A participant may also, in some cases, be a non-human entity. For example, participant E at computing device 112 may comprise a software application that interacts with another (human) participant using voice prompts, such as some types of automated answering services. This software application may intentionally use background noise so that its voice prompts sound more real.

The environment also has a communications network 114, such as a company intranet or a global internet (e.g., the Internet). The participants' devices may be capable of communicating directly with the network (e.g., a wireless-Internet enabled laptop, PDA, or a Tablet PC, or a desktop computing device or VoIP-enabled telephone or cellular phone wired or wirelessly connected to the Internet) or indirectly (e.g., the telephone connected to the phone-to-network device). The conversation or conference may be enabled through a distributed or central network topology (or a combination of these). Exemplary distributed and central network topologies are illustrated as part of an example described below.

The communication network and/or any of these devices, including the phone-to-network device, may be a computing device having one or more processor(s) 116 and computer-readable media 118 (each device marked with “◯” to indicate this possibility). The computer-readable media comprises a voice handler 120 having one or more of a voice activity detector 122, an encoder 124, a decoder 126, an adaptive history module 128, a noise history 130, and a comfort noise generator 132. The noise history may comprise or have access to a frequency template 134 and an excitation template 136.

The processor(s) are capable of accessing and/or executing the computer-readable media. The voice handler is capable of sending and receiving audio communications over a network, e.g., according to a Voice-over-Internet Protocol (VoIP). The voice handler is shown as one cohesive unit with the mentioned discrete elements 122-136, though portions of it may be disparately placed, such as some elements residing in network 114 and some residing in one of the other devices.

Each of the participants may contribute and receive audio signals. The voice activity detector is capable of determining whether contributed audio is likely a participant's speech or not. Thus, if participant A (“Albert”) stops speaking, the voice activity module executing on Albert's communication device may determine that the audio signal just received from Albert comprises background noise and not speech. It may do so, for instance, by measuring the intensity and duration of the audio signal.

The encoder converts the audio signal from an analog format to a digital format and into packets suitable for communication over the network (each typically with a time-stamp). The decoder converts packets of audio received over the network from the encoder into analog suitable for rendering to a listening participant. The decoder may also analyze packets as they are received to provide information about the energy and frequency of the payload (e.g., a frame of audio contained in a packet).

The adaptive history module is capable of building and adapting noise history 130 based on information about background noise in audio received from one or more speaking participants. In some cases the information includes frequency and excitation information for a participant's background noise. In these cases the history module is capable of building the noise history to include frequency template 134 and excitation template 136 for that participant. The noise history may be used by the comfort noise generator to generate comfort noise that adapts to changes in a speaker's background noise. Many of the elements of the operating environment are mentioned and further described as part of the description below.

### Building and Adapting an Exemplary Noise History

The following discussion describes exemplary ways in which the tools may build and adapt a noise history for later use in generating comfort noise. This discussion uses elements of operating environment 100 of FIG. 1, though other elements or other environments may also be used.

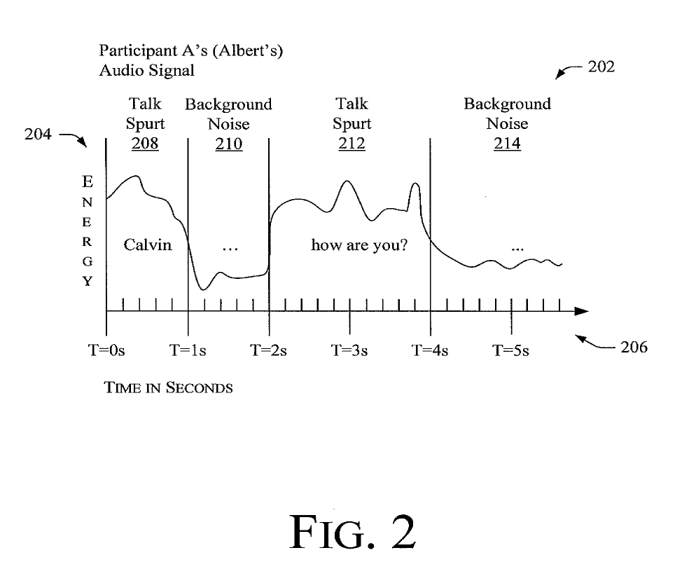

For this example assume that participant A of FIG. 1 (“Albert”) is speaking to participant C also of FIG. 1 (“Calvin”). Albert talks in talk-spurts, that is, he is speaking some but not all of the time. People often talk in spurts followed by short or long delays between further spurts of speech. For example, assume that Albert says: “Calvin . . . how are you? . . . ”. This represents two talk spurts, namely “Calvin” and “how are you?” each of which are followed by times in which Albert is not speaking. This is represented graphically in FIG. 2.

FIG. 2 shows a graph 202 of the energy 204 of the audio signal received by Albert's communication device 102 versus time 206. The graph shows a first talk spurt at 208 (“Calvin”), a first background noise portion at 210, a second talk spurt at 212 (“how are you?”), and a second background noise portion at 214.

Albert's communication device 102 receives this audio signal having speech and background noise. As shown in FIG. 2, the speech has a higher energy (e.g., higher volume) than the background noise. The background noise may have many components, such as people talking in another room away from Albert, the hum of the heating system or air conditioning, a fan, and traffic (especially if Albert is on a mobile phone). Note that the background noise may change—people in the background may stop talking, traffic may get louder, or the air conditioning may turn off.

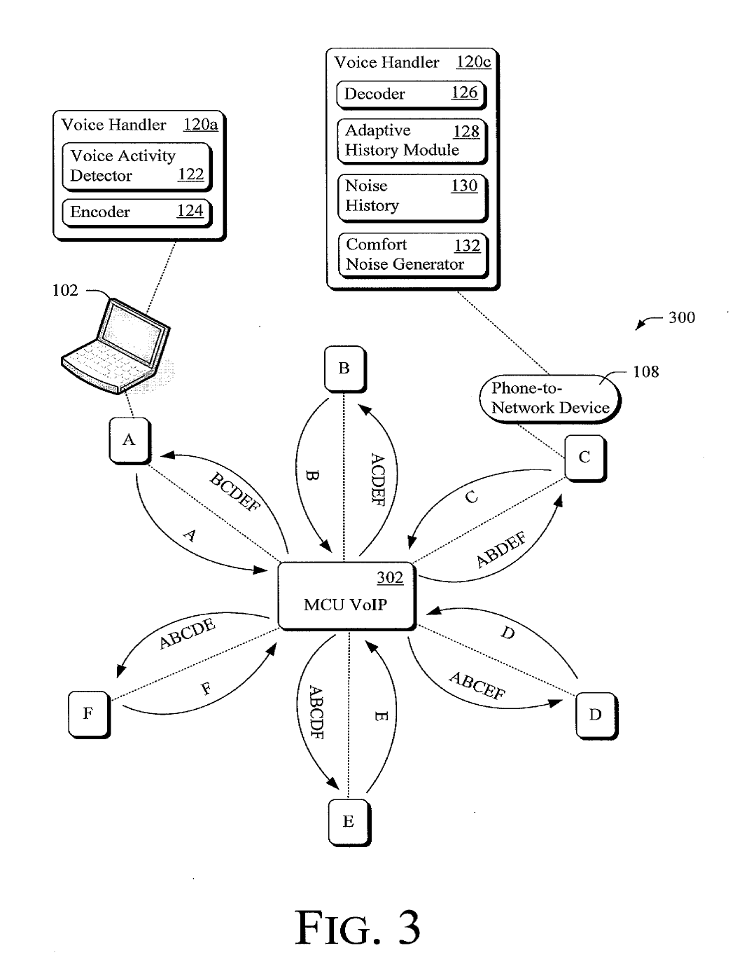

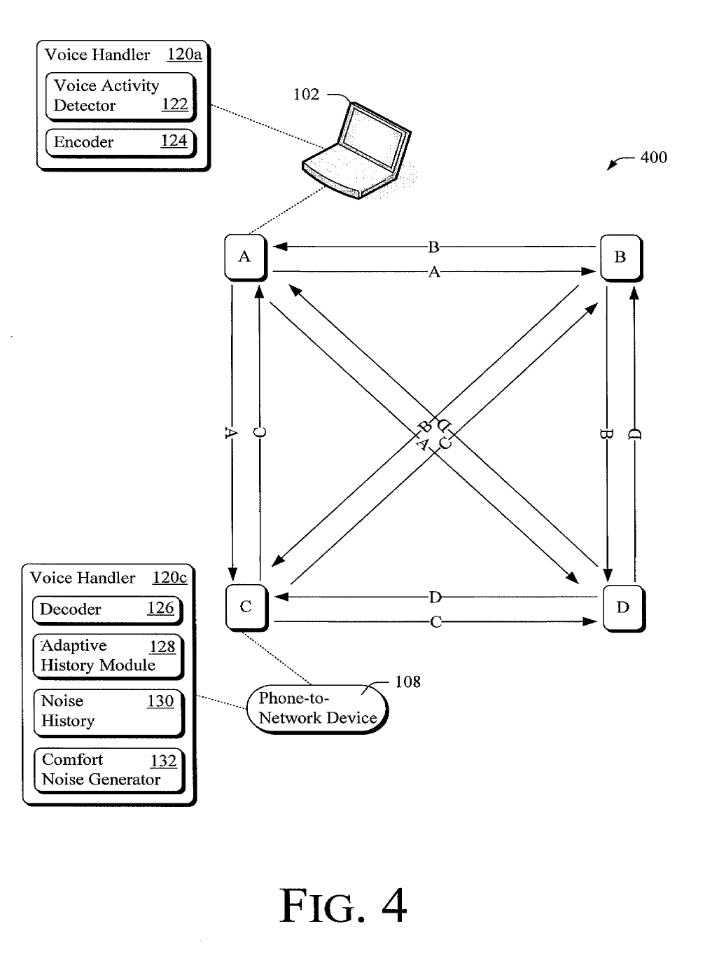

FIGS. 3 and 4 show Albert's communication device 102, which receives this audio signal, a centralized network 300 or a distributed network 400, and participant C's phone-to-network communication device 108 receiving information over the network. FIGS. 3 and 4 illustrate centralized and distributed communication networks, respectively, and show other participants capable of sending and receiving audio with each other (e.g., participant B may contribute audio “B” and receive audio from “A”, “C”, “D”, “E”, and “F” from these other participants in FIG. 3 or “A”, “C”, and “D” in FIG. 4). FIG. 3 includes a multi-point control unit for VoIP 302 residing on one or more servers accessed through network 114. Each of the communication devices in FIG. 4 act to enable functions similar to those of the MCU of FIG. 3.

Albert's device is shown with its own voice handler marked as 120a rather than 120 to show that it is associated with Albert. For simplicity, Albert's voice handler 120a is shown only with voice activity detector 122 and encoder 124. Calvin's device is shown with Calvin's voice handler 120c having only (again for simplicity) decoder 126, adaptive history module 128, noise history 130, and comfort noise generator 132. This ongoing example and the tools in general may use either a network having a distributed topology, centralized topology, or a combination of both (combination not shown).

In any of these topologies, Albert's communication device receives his audio signal in analog form, namely “Calvin . . . how are you? . . . ”. Albert's device's voice handler receives the audio in analog form, converts it into a digital form (e.g., with a voice card), and determines which parts of the signal are speech and which are background noise. Here the voice activity detector determines that the signal comprises the four portions shown in FIG. 2 (two talk-spurts and two background noise portions). The voice handler then determines what portion of the signal to packetize and send to the network. Here the talk-spurts and segments of background noise that immediately follow the talk-spurts (e.g., 0.5 seconds) are packetized and sent.

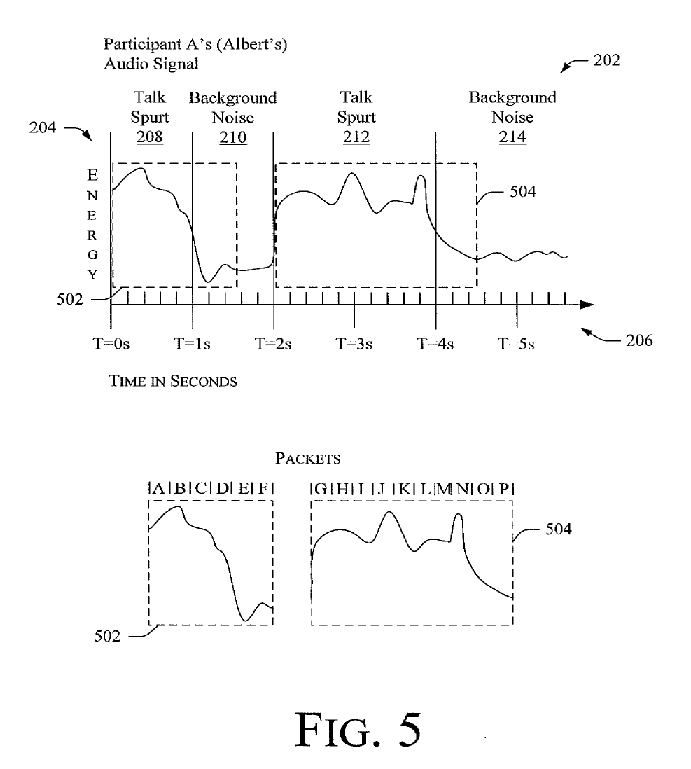

FIG. 5 illustrates the graph 202 of FIG. 2 but showing the two portions of Albert's audio signal that are processed and sent over the network, namely a first talk-and-noise portion marked at 502 and a second talk-and-noise portion marked at 504 (both in dashed-line boxes). Note that the background noise from times 1.5 seconds to 2 seconds and all the background noise after 4.5 seconds (until the next talk-spurt, if any) are not sent. The talk-and-noise portions 502 and 504 are also shown broken into a small number of packets, namely A-F for portion 502 and G-P for portion 504. This small number is for simplicity of explanation, in actuality, each of these portions would likely be packetized in many more packets than are shown. The packets sent over the network are received by participant C's (Calvin's) phone-to-network device 108.

Note, however, that a talk-and-noise portion may include background noise segments that are not at the end of the talk-spurt. For example, if Albert paused for ¼ second between “how” and “are you”, the pause would likely be considered background noise. The voice handler may send a talk-and-noise portion having just this ¼ second of background noise with or without any background noise following “are you”. If the voice handler does so, the segment of background noise surrounded by speech in a talk-and-noise portion may be used by the tools similarly to the background noise received after a talk-spurt, including to adapt a noise history.

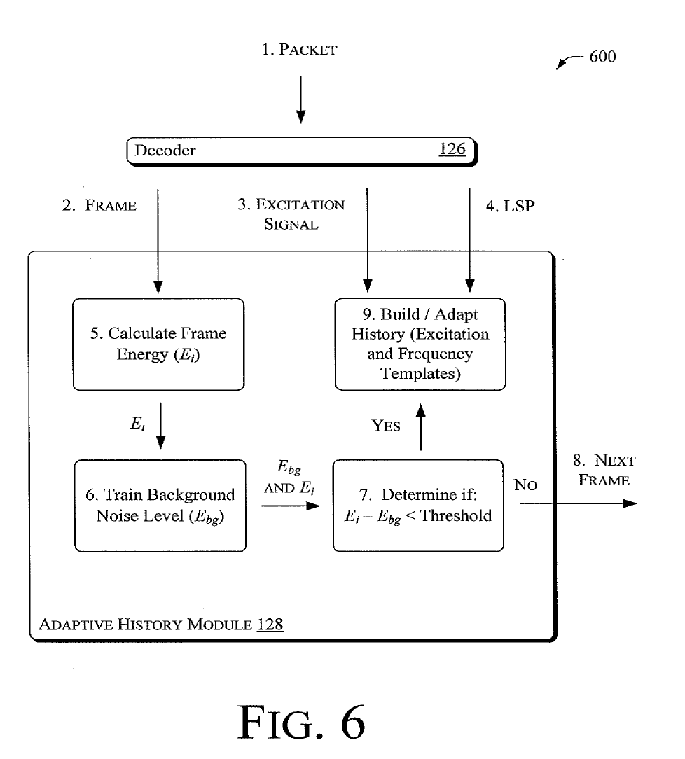

FIG. 6 is a flow diagram showing what happens at Calvin's device 108 as the packets for the ongoing communication are received—namely actions and interactions of and between Calvin's decoder 126 and adaptive history module 128.

Calvin's device receives packets A through P at decoder 126, shown at action 1. These packets are received from the network and include digital data for both talk-and-noise portions of FIG. 5. Assume that packets are first put in chronological order (they are often received slightly out of order) at or prior to receipt by the decoder.

The decoder receives packets for the talk-and-noise portions at which time it strips the data from each packet to provide data frames. Assume, for simplicity, that the decoder receives packets A, B, C, D, E, and F in turn. Packets A-D represent part of the talk-spurt portion of the first talk-and-noise portion (from when Albert said: “Calvin”). Packets E and F represent background noise in the segment following the talk-spurt. On receiving each of these packets, the decoder provides frames for each, shown at action 2. Also on receiving each packet, the decoder determines an excitation signal (X) and Linear Spectral Parameters (LSP) for each frame (Xᵢ and LSPᵢ for each frame, with “i” being the frame at issue).

The excitation signal and LSP of a frame are used by the adaptive history module when the energy of that frame is consistent with background noise rather than speech. The adaptive history module receives each frame at action 2, with which it determines each frame's energy (Eᵢ) at action 5. At action 6, the module uses the frame's energy, whether background noise or speech, to better assess in the future what is speech and what is background. Here the module uses a frame's energy to train a background noise level, represented by E_{bg}. The module may train the E_{bg} to represent a running average of minimum-energy frames.

At action 7 the adaptive history module determines if the frame at issue (here frame A-F in turn) is background noise or not. The module does so by subtracting the background noise level (E_{bg}) from the energy of the current frame (Eᵢ) and, if the remainder is less than a threshold energy, determines that this frame is background noise. This threshold may be predetermined or adaptive based on energy information. Here the threshold is a predetermined constant value having a particular dB (decibel) value. If the frame is determined not to be background noise, the adaptive history module proceeds to analyze the next frame's energy at action 8. If the frame is determined to be background noise and not speech (the “Yes” arrow), the module proceeds to action 9.

At action 9 the module builds and/or adapts noise history 130 of FIG. 1 by adapting the excitation template and frequency template for participant A (Albert). To do so, the module receives the excitation signal for the frame at issue (Xᵢ) and the LSP for the frame at issue (LSPᵢ) from the decoder and updates the excitation template based on the excitation signal and the frequency template based on the LSP.

For Albert's talk-spurt of “Calvin”, which was received by Calvin's communication device with packets A, B, C, and D, the adaptive history module determines that none of the frames for these packets contain just background noise. Thus, for time T=0 through T=1 in FIG. 5 (talk spurt 208), the adaptive history module does not adapt the noise history for Albert's audio signal.

For the segment of background noise after the talk-spurt of “Calvin”, which was received by Calvin's communication device with packets E and F, the adaptive history module determines that both frames for these packets contain background noise and not speech. Thus, for times T=1 to T=1.5 in FIG. 5, the adaptive history module adapts the noise history for Albert's audio signal.

Here the decoded excitation signal X(E) (for the frame of packet E) and X(F) (for the frame of packet F) are used to update the excitation template E_{T}. These excitation signals X(E) and X(f) are noise vectors representing an average energy of the signal in their respective frames E and F. The adaptive history module updates the excitation template based on each of these vectors.

The module updates the excitation template E_{T} according to the following formula:

E_{T}(j)=α·E_{T}(j)+(1−α)·|X(j)|

where j=1, . . . . N and N is the frame length, α is a training weight (e.g., 0.9 or 0.99), and X is the current excitation signal.

Thus, for the frame of packet E, assuming it is the first frame of background noise and the training weight is 0.9, the excitation template is:

E_{T}(E)=0.9·0+(1−0.9)·|X(E)|=0.1|X(E)|

For frame F, the starting excitation template would be 0.1|X(E)| resulting in an adapted excitation template based on frame F of:

E_{T}(F)=0.9·0.1|X(E)|+(1−0.9)·|X(F)|

E_{T}(F)=0.09|X(E)|+0.1|X(F)|

At first it may seem that the value of excitation template should be larger. With the large number of packets typically received in a segment of background noise, however, the module may quickly adapt the excitation template to a value that is a close approximation of the background noise's excitation. Also, for the first frame used (here E), the adaptive history module may set the training weight to a smaller value (and thus a larger effect). If the training weight was set for the first frame at 0, for example, the excitation template following adaptation of frame F would be:

E_{T}(F)=0.9|X(E)|0.1|X(F)|

If the excitation of E and F were about equal, then the excitation template would be:

E_{T}(F)≈|X(F)|

The adaptive history module also updates the noise history's frequency template. Here Linear Spectral Parameters (LSP) for frames from packets E and F, namely L(E) and L(F), are used to update the frequency template L_{T}. These LSPs represent linear prediction filters for their frames E and F. The adaptive history module updates the frequency template based on each of these LSPs.

Here the module first updates the frequency template L_{T} according to the following formula:

L_{T}(j)=β·L_{T}(j)+(1−β)·L(j)

where j=1 . . . M and M is the order of the linear prediction filter (e.g., 10 or 16), β is a training weight (e.g., 0.9 or 0.99), and L is the current LSP. Initially (e.g., at receipt of the first packet) the adaptive history module may use the very first received packet's LSP or use a uniformly spaced LSP as initialization. A uniformly spaced LSP generates a flat spectrum in the frequency domain. Here we assume that the initial LSP used is the LSP of frame E. Thus, for the frame of packet E, assuming a training weight is 0.9, the frequency template is:

L_{T}(E)=0.9·L(E)+(1−0.9)·L(E)=1.0L(E)

For frame F, the starting frequency template would be 1.0 L(E) resulting in an adapted frequency template based on frame F of:

L_{T}(F)=0.9·1.0L(E)+(1−0.9)·L(F)

L_{T}(F)=0.9L(E)+0.1L(F)

Similarly to the excitation template above, the module may quickly adapt the frequency template to a value that is a close approximation of the background noise's spectral shape. Again, for the first frame used, E, the adaptive history module may set the training weight to a smaller value (and thus a larger effect). If the training weight was set for the first frame at 0.2 (for E) and 0.3 (for F) eventually increasing by 0.1 to 0.9, for example, the frequency template following adaptation based on frame F would be:

L_{T}(E)=0.2·L(E)+(1−0.2)·L(E)=1.0L(E)

L_{T}(F)=0.3·1.0L(E)+(1−0.3)·L(F)=0.3L(E)+0.7L(F)

If the LSPs of E and F were about equal, then the frequency template would be:

L_{T}(F)≈1.0L(F)

In practice the segment of background noise sent with the talk-spurt in the speech-and-noise portion 502 often has enough packets such that the excitation template and frequency template is a weighted average of these parameters for the noise received, with the noise more-recently received having greater weight.

### Adaptively Generating Comfort Noise

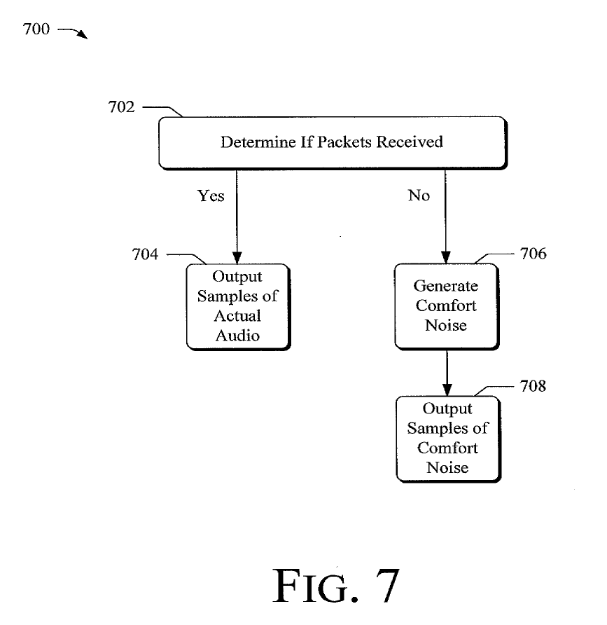

At some point, however, the decoder does not receive additional packets for the ongoing communication; here there is a lull after packet F is received. This lull may be determined analytically or be indicated in a packet (e.g., in packet F that F is the last packet). Responsive to this lull, the tools generate comfort noise to fill in noise after packet F is received and rendered to the listener (e.g., Calvin). An overview of these actions of the tools is set forth in FIG. 7 at process 700, which illustrates actions of the voice handler in response to receiving or not receiving packets.

At block 702, the voice handler determines if it has received packets for Albert's audio signal. If packets are being received and are of an appropriate time-stamp (e.g., not for audio to be rendered later for a future-rendered talk-spurt), the process continues along the “Yes” path to block 704.

At block 704 the voice handler outputs samples of the frames for the packets effective to enable a participant to hear the actual audio received in the packets. Here the loud speakers on Calvin's communication device (his telephone) act responsive to a signal from his phone-to-network device 108 to broadcast the signal for speech-and-noise portion 502 (“Calvin” with a segment of background noise) based on the output samples. Thus, Calvin hears Albert say: “Calvin” and some actual background noise.

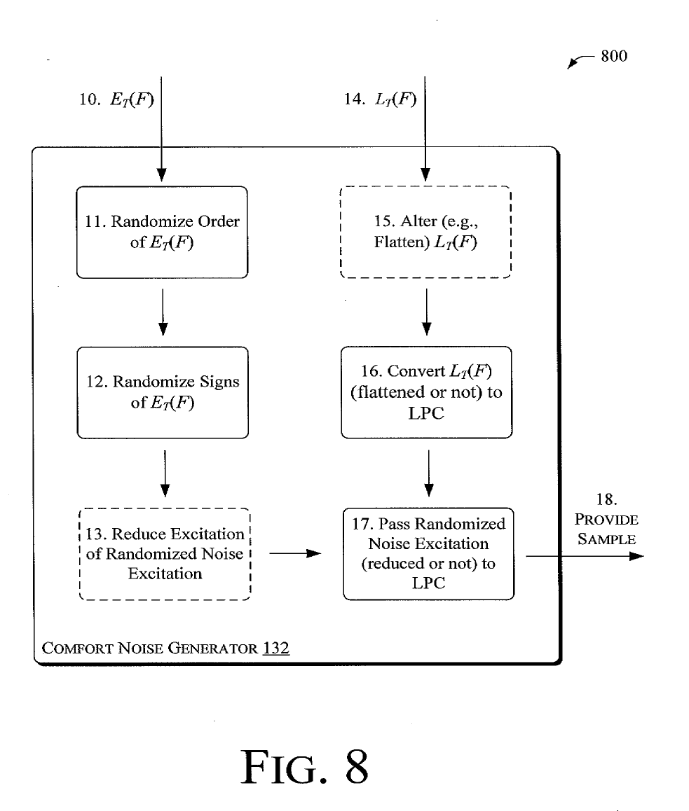

If, however, packets are not received of an appropriate time-stamp, the voice handler proceeds to block 706. At block 706, comfort noise generator 132 of FIG. 1 generates comfort noise. For this example, the generator generates comfort noise based on the excitation template and the frequency template, as built and altered above. Exemplary ways in which the voice handler may generate comfort noise are detailed at FIG. 8.

The voice handler outputs samples for rendering the comfort noise to a participant at block 708. Here again, Calvin's telephone acts responsive to a signal from his phone-to-network device to broadcast sounds, only here the sounds are comfort noise.

With the overview of process 700 set out, the discussion turns to exemplary and more-detailed ways in which the comfort noise generator generates comfort noise shown in overview with block 706 above.

FIG. 8 is a flow diagram 800 showing actions of Calvin's device's comfort noise generator and continues the example of FIG. 6. At FIG. 6, Calvin's adaptive history module 128 built/adapted an excitation template and a frequency template for background noise received from Albert. At FIG. 8, Calvin's comfort noise generator 132 uses the most up-to-date excitation template and frequency template to generate comfort noise.

At action 10 in FIG. 8, the generator receives the excitation template E_{T}(F) adapted by the adaptive history module at action 9 in FIG. 6, which is up-to-date as of packet F.

At action 11, the generator randomizes the order of the excitation template. At action 12, the generator randomizes the signs of the excitation template as well. By randomizing the order and sign but not the absolute values of the amplitude of the excitation template, the energy of the excitation vector is constant or nearly constant. Thus, the comfort noise generated can be of constant energy (i.e., volume). Comfort noise of a constant volume may be pleasing and non-disruptive to listeners. The randomizations of actions 11 and 12 may be described mathematically as:

```
For (i = 1 to N)
    X[i] = E_{T}(i)
For (i = 1 to N)
    Temp = X[i]
    i_rand = rand( ) % N
    sign_rand = 2rand( ) % 2 − 1
    X[i] = X[i_rand]
    X[i_rand] = Temp * sign_rand
```

The output of actions 11 and 12 is a randomized noise excitation. Optionally at arrow 13, however, the generator may reduce the amplitude of excitation (e.g., progressively over time). Thus, at the first comfort noise sample the excitation may be nearly equal to the randomized noise excitation produced by actions 11 and 12. Over the next ¼ second, ½ second, or more, the generator may gradually reduce the energy of the randomized noise excitation. In some cases listeners prefer that comfort noise progressively get quieter, though often at a rate that is not immediately noticeable. If Albert is talking on a cell phone in heavy traffic, for instance, the background noise could be annoying for Calvin. For example, the generator may start the comfort noise at about the same excitation (volume) as the actual noise and then, over the first five seconds reducing it by about a ¼, then another ¼ over the next five seconds until the high-volume background noise is noticeable but not annoying.

At action 14, the generator receives the frequency template L_{T}(F) adapted by the adaptive history module at action 9 in FIG. 6, which is up-to-date as of packet F. At arrow 15, the generator optionally alters the frequency template. The generator may, either progressively over time or all at once, “flatten” frequency peaks or irregularities in the frequency template. Doing so may make the comfort noise more pleasing to a listener.

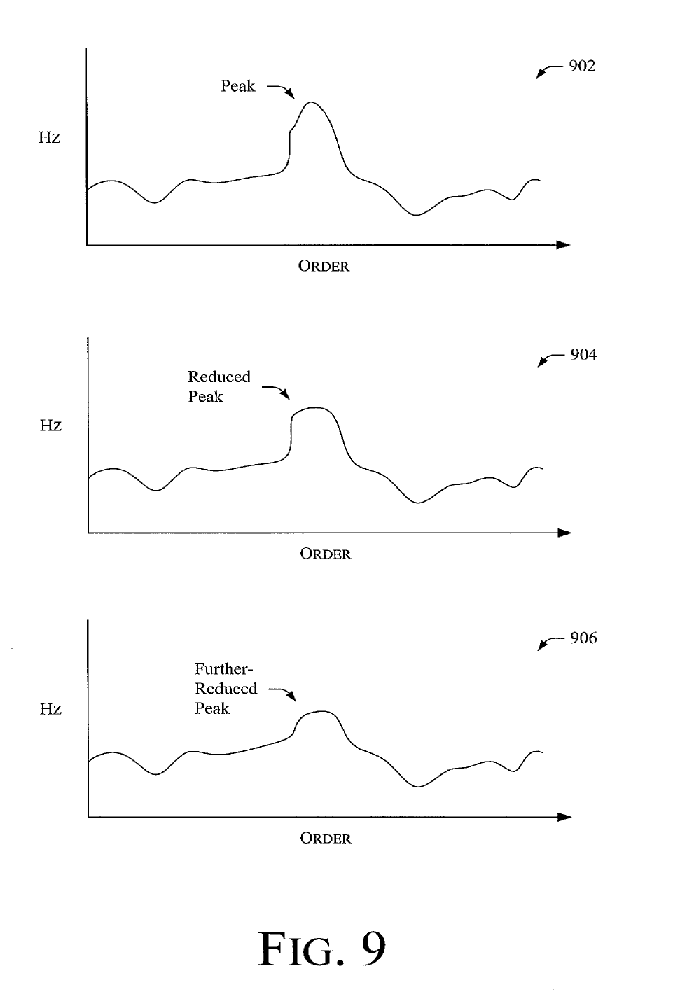

Assume, for example, that the frequency template represents a frequency spectrum as shown in FIG. 9 at 902. This frequency spectrum shows a peak (e.g., 880 hertz). This could be from the actual background noise having a moderately high-pitched whine from a fan, for example. Many listeners, however, prefer not to hear irregularities in a frequency spectrum or at least prefer that the irregularity drop away over time. The frequency template may, at action 15, be altered as shown at 904. Over time, such as 5 seconds later, the generator may produce comfort noise matching a frequency template shown at 906. Action 15 may continually alter the frequency template, though here the alteration is only until the next talk-and-noise portion 504 is received.

At action 16 the generator converts the frequency template L_{T}(F) to a Linear Predictive Coding (LPC) template. This template is suitable for acting as a linear prediction synthesis filter with the excitation to generate the comfort noise.

At action 17 the generator passes the randomized noise excitation from action 12 or 13 to the LPC synthesis filter. The LPC may result from actions 15 and 16 or just 16. The result is a sample that may be rendered to produce comfort noise. The comfort noise sample is provided at action 18.

The generator continues to provide comfort noise samples until the next talk-and-noise portion is received by Calvin's phone-to-network device 108. The adaptive history module 128 continues to receive frames, excitation signals, and LSPs for packets G-P in the ongoing communication, shown in FIG. 5. Like packet F in the prior discussion related to FIGS. 5 and 6, the adaptive history module continues to adapt the history based on background noise packets received, here packets O and P but not G, H, I, J, K, L, M, and N of talk-and-noise portion 504 of FIG. 5. Also as noted in the above discussion, the adaptive history module determines that these other packets G-N are not background noise and so do not use them to adapt the noise history. As noted in FIG. 7, the tools output actual audio until a lull, then comfort noise, then actual audio again until another lull, then comfort noise and so forth. Thus, the tools output actual audio for times T=0 s to 1.5 s, then comfort noise for T=1.5 s to T=2 s, then actual audio for T=2 s to T=4.5 s, then comfort noise after T=4.5 s.

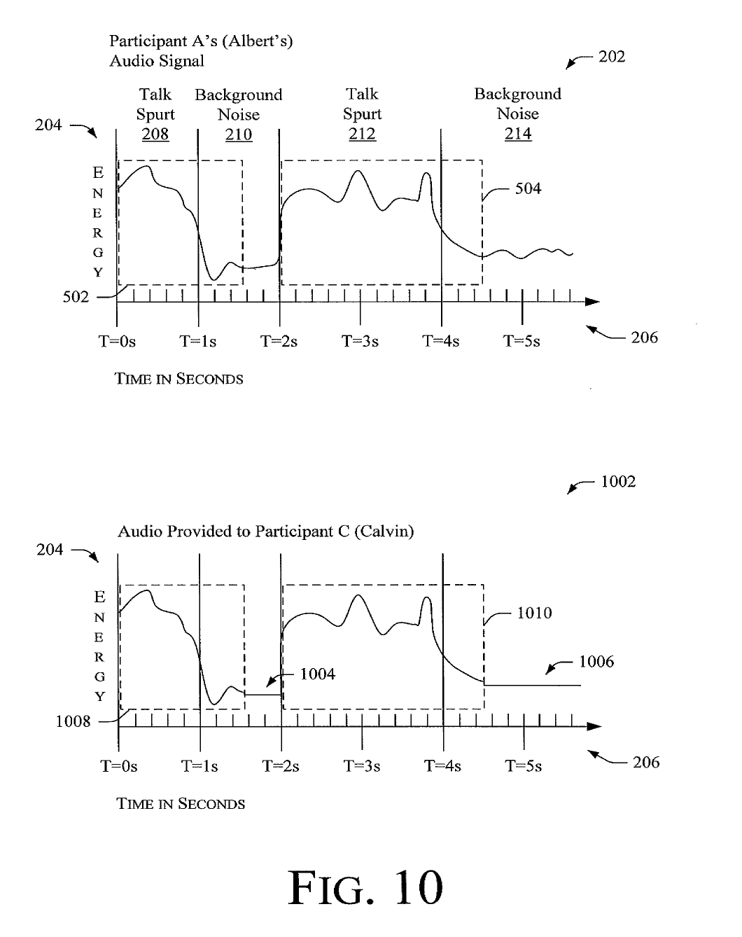

The energy of the audio rendered for all of the audio signal received from Albert (“Calvin . . . how are you? . . . ”) is presented in FIG. 10 at 1002 along with the original audio signal from FIGS. 2 and 5 for comparison (graph 202). Note that instead of background noise at times T=1.5 to T=2 and T=4.5 to T=5.5+in graph 202, first comfort noise 1004 and second comfort noise 1006 are generated at these times. Here we assume that the energy of the comfort noise is not reduced over time (it is flat). The talk-and-noise portions 502 and 504 are rendered with first and second rendered talk-and-noise 1008 and 1010, respectively. Note that the comfort noise mirrors very closely the actual energy of the background noise received. The first comfort noise is shown with an energy that is a weighted average of the energy of the background noise between T=1 s and T=1.5 s. The second comfort noise is shown with an energy that is a weighted average of the energy of the background noise between both T=1 s and T=1.5 s and T=4 s and T=4.5 s based on background noise frames from packets E, F, O, and P. This illustrates that the comfort noise generated adapts to changes in the actual background noise, as noted by the higher energy level of the second comfort noise compared to the first.

### Additional Embodiments

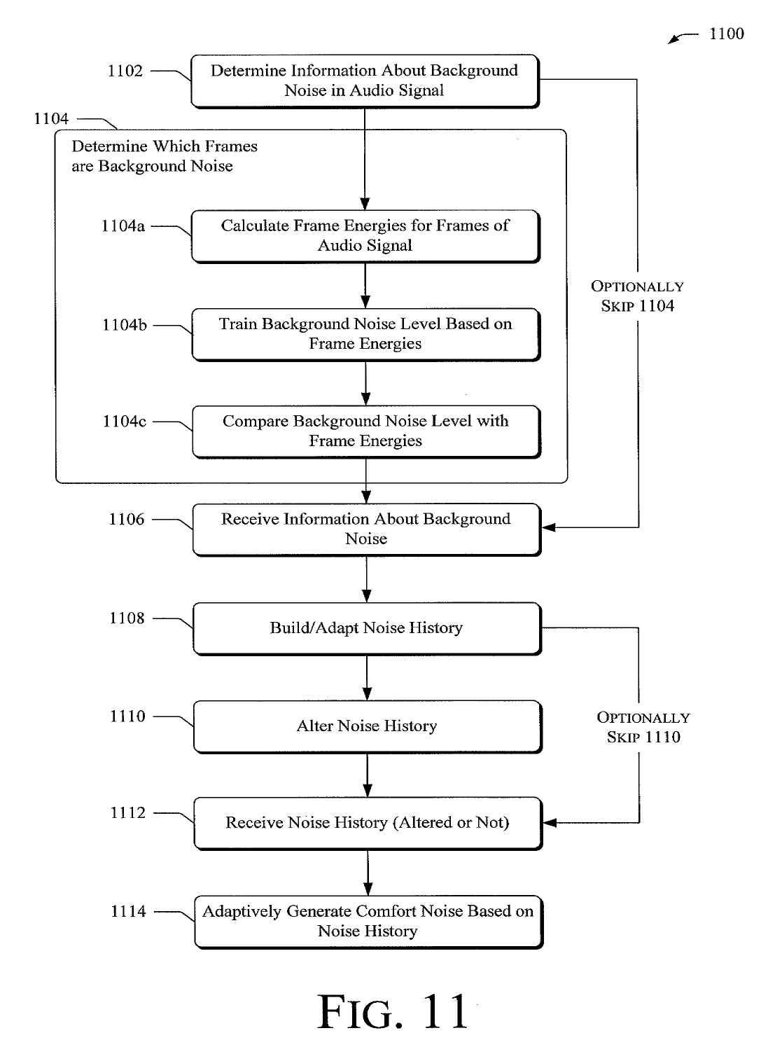

The following discussion, which is illustrated in FIG. 11 with process 1100, describes additional embodiments of the tools representing various ways in which the tools may act to enable and generate comfort noise. This process is illustrated as series of blocks representing individual operations or acts performed by the tools, such as elements of operating environment 100 of FIG. 1, e.g., voice handler 120, adaptive history module 128, and comfort noise generator 132, though other elements or operating environments may be used. These and other processes and actions disclosed in this document may be implemented in any suitable hardware, software, firmware, or combination thereof; in the case of software and firmware, they represent sets of operations implemented as computer-executable instructions stored in computer-readable media and executable by one or more processors.

Block 1102 determines information about a segment of background noise in an audio signal. This segment may reside in any part of an audio signal, such as following a talk spurt in a talk-and-noise portion as set forth above, or residing within a talk-spurt, such as a short period of background noise between two pieces of speech, or even background noise not immediately before or after a talk-spurt. This segment information indicates parameters of the actual background noise, such as its energy and frequency spectrum. In the embodiments described above, for example, this information includes an excitation signal and a Linear Spectrum Predictor (LSP) for frames of audio decoded from packets received over a communication network according to VoIP.

Block 1102 may determine this information frame-by-frame for a segment of background noise, such as for a segment received immediately after or within a talk-spurt (e.g., as part of a talk-and-noise portion of an audio signal) as described above. The tools may determine this just for packets known to contain background noise or for all packets, as is performed by decoder 126 in the above examples. An encoder on a speaker's communication device may indicate which packets represent background noise and which do not. Block 1104 assumes that the packets do not indicate or do not indicate accurately which represent background noise and which do not. Thus, these blocks act to determine which packets have frames of background noise. If the packets accurately indicate which represent background noise, the tools may skip block 1104 and proceed to block 1106.

Block 1104 determines which frames represent background noise. In one embodiment, the tools do so according to blocks 1104a, 1104b, and 1104c, though other manners may also be used in conjunction with or alternatively to the manners set forth in blocks 1104a through 1104c. These other manners may include, for example, determining which frame represents background noise based on: signal analysis of a frame; features extracted from a frame; embedded side information about the nature of the frame as side-info or metadata in the packet having the frame; the rate at which packets are received or packet size of the packet having the frame; or an indication in the frame itself that the frame is speech or background noise.

Block 1104a calculates frame energies for frames of an audio signal received over a communication network. Block 1104b trains a background noise level based on the frame energies. Thus, as new frames are received, the tools update the background noise level to better determine which frames contain just background noise and which do not. The background noise, as noted in the above examples, may change over time. Some frames that would have been considered noise at one point may not be considered noise at a later point in time, or vice versa. By updating and adapting to changes in background noise, the tools may more accurately determine which frames represent background noise and which do not.

Block 1104c compares each frame's energy with the background noise level. The tools may determine which frames represent background noise by comparing the frame's energy with an adapting background noise level. In FIG. 6, for example, the adaptive history module determines that a frame contains just background noise if the frame's energy (Eᵢ) minus the background noise level (E_{bg}) is less than a threshold amount. This threshold may be predetermined, including based on various parameters, such as the type of device on which a speaker is speaking. If the tools determine that a frame represents background noise, the tools proceed to block 1106.

Block 1106 receives information about background noise. Whether following block 1104 or 1102, block 1106 knows which frames are considered background noise and their information. In some of the above examples, for instance, the tools receive a talk-and-noise portion of an audio signal, determine which represent background noise based on their energy, and proceed with the information from the frames determined to be background noise. The segment of the audio signal determined to be background noise may include information for one or many frames determined to represent background noise. In the talk-and-noise portion 502 of FIG. 5, for instance, the segment of noise was represented by two packets E and F and was ½ second long (from T=1 s to T=1.5 s), though this is for simplicity as ½ second would likely need many more packets than two.

Block 1108 builds and/or adapts a noise history based on segment information about background noise in an audio signal of an ongoing communication. The tools provide updates or directly adapt this noise history responsive to changes in background noise to better enable generation of comfort noise. In the above examples, for instance, this segment information about the background noise includes excitation signals and LSPs for frames decoded from packets received over communication network 114 of FIG. 1. The noise history from this example contains frequency template 134 and excitation template 136. The tools may continually update these templates as new frames or segments of background noise are received. Thus, for each talk-and-noise portion received, the tools may determine excitation signals and LSPs for each frame, determine which represent noise and which do not, and use the excitation signals and LSPs for frames that represent noise to update the frequency template and excitation template.

Block 1110 optionally alters the noise history to enable production of a more-pleasing comfort noise. In some cases the noise history, while accurate, may be altered to enable more-pleasing but possibly less-accurate comfort noise. If, for example, the frequency template contains a frequency peak that may be annoying or if the excitation template is simply too loud for comfort, the tools may alter these templates. As noted later, the tools may also or instead alter the templates during generation of comfort noise. In either case, whether following block 1108 or 1110, the tools provide a noise history effective to enable generation of comfort noise.

In all of process 1100, the tools may act at the listener's communication device. Thus, the outputting communication device (e.g., an encoder at the speaker's device) does not necessarily need to do anything more than provide audio containing speech and at least some audio containing background noise.

All of blocks 1102-1110 may be repeated. As new frames or segments of background noise are received, their information may be used to adapt the noise history. In the example illustrated in FIG. 5, for instance, frames E and F were used to build and adapt the noise history. Information about another segment of background noise, that of frames O and P, were later analyzed for segment information and used to further adapt the noise history. Thus, the tools may continually adapt the noise history effective to enable adaptive generation of comfort noise by repeating parts or all of process 1100. The tools may also weight some segment information or frame information more heavily than others, such as by weighting newest segment information more heavily than older segment information (e.g., more-heavily weighting the background noise of talk-and-noise 504 than talk-and-noise 502 shown in FIG. 5).

Block 1112 receives a noise history indicating information about actual background noise in an audio signal received over a communication network. This noise history may have been built at the receiver, such as is described in some of the above examples. This noise history includes information usable to generate comfort noise and may be altered adaptively based on new background noise received. Thus, newer, adapted noise histories or updates to the noise history may be used, thereby enabling comfort noise to dynamically adapt to changes in background noise. This noise history may comprise, as described above, the frequency and excitation templates. In some cases block 1112 (e.g., the comfort noise generator) receives the noise history by actively accessing the noise history as needed to keep up-to-date.

Block 1114 generates comfort noise adaptively based on changes in background noise of an audio signal, such as based on how those changes are reflected in a changing noise history. If the noise history changes, such as when it is adapted based on changes in background noise, a different, adapted noise history is instead received or the prior history is altered (e.g., with an update). Block 1114 may generate comfort noise based on the most-recent noise history. Thus, the tools may generate comfort noise at one point in time and later generate different noise based on changes to the actual comfort noise in the audio signal effective to dynamically adapt comfort noise to changes in background noise in real-time and as a communication progresses.

The tools may perform various actions to generate comfort noise, such as those set forth in FIG. 8. There the comfort noise generator generated the comfort noise by randomizing an order and signs of an excitation template, converted the frequency template into an LPC, and passed the randomized excitation template through the LPC synthesis filter. The tools may also alter either of the templates as part of generating the comfort noise or as part of preparing the noise history. These alterations may enable comfort noise to be more pleasing to listeners.

### CONCLUSION

The above-described tools are capable of enabling and/or generating comfort noise for voice communications over a network. The tools may adapt to changes in a speaker's background noise effective to generate comfort noise that also adapts to these changes. And, the tools may do so at significant bandwidth savings over some other techniques. Although the tools have been described in language specific to structural features and/or methodological acts, it is to be understood that these are defined in the appended claims are not necessarily limited to the specific features or acts described. Rather, the specific features and acts are disclosed as exemplary forms of implementing the appended claims.

1. A method implemented at least in part by a computing device comprising:
receiving, over a communication network and for an ongoing Voice-over-Internet Protocol (VoIP) communication, packets containing background noise of the VoIP communication, the background noise changing over time; and
adaptively generating comfort noise that dynamically changes responsive to the background noise changing over time.

2. The method of claim 1, further comprising adapting a noise history based on changes in the background noise and wherein the act of adaptively generating comfort noise that dynamically changes is based on the noise history adapting.

3. The method of claim 1, wherein the act of adaptively generating comfort noise uses an excitation template based on excitation information for frames of background noise and a frequency template based on Linear Spectrum Predictor (LSP) information for frames of background noise and wherein the excitation template or the frequency template dynamically changes based on the background noise changing over time.

4. The method of claim 1, wherein:
the background noise is received in a plurality of segments, at least one of the segments in or following a different talk-spurt in the VoIP communication than at least one other of the segments; and
the act of adaptively generating comfort noise generates comfort noise that adapts to the segments as they are received.

5. One or more computer-readable media having computer-readable instructions therein that, when executed by a computing device, cause the computing device to perform acts comprising:
receiving segment information about a segment of background noise in an audio signal of a VoIP communication; and
adapting, responsive to receiving the segment information and based on the segment information, a history of information about background noise of the VoIP communication that is usable to generate comfort noise.

6. The media of claim 5, further comprising building the history prior to the act of adapting the history and based on previously received segment information about previous segments of background noise of the VoIP communication.

7. The media of claim 5, wherein the audio signal comprises a talk-spurt and the segment of the background noise.

8. The media of claim 7, wherein the segment of the background noise is received within or immediately following the talk-spurt.

9. The media of claim 7, further comprising receiving the audio signal having the talk-spurt and the segment of background noise and determining that the segment of background noise is background noise and not speech.

10. The media of claim 9, wherein the act of determining that the segment of background noise is background noise is based on: signals of the segment; features extracted from the segment; embedded metadata in one or more packets in which the segment of background noise is received; a rate of receipt of one or more packets in which the segment of background noise is received; a packet size of one or more packets in which the segment of background noise is received; or an indication in the segment that the segment is or is not background noise.

11. The media of claim 9, wherein the act of determining that the segment of background noise is background noise determines, for each frame of the segment, an energy level of each frame and that the energy level of each frame minus a running average of prior frames of the VoIP communication determined to have minimum energy levels is below that of a threshold energy level.

12. The media of claim 5, wherein the segment information comprises an excitation signal and a Linear Spectrum Predictor (LSP) for a frame of the segment.

13. The media of claim 12, wherein the act of adapting the history of information comprises adapting a frequency template based on the LSP of the frame of the segment.

14. The media of claim 12, wherein the act of adapting the history of information comprises adapting an excitation template based on the excitation signal for the frame of the segment.

15. The media of claim 5, further comprising providing the history of information after the act of adapting the history of information and effective to enable generation of comfort noise capable of adapting to changes in background noise of the VoIP communication.

16. The media of claim 5, further comprising:
receiving additional segment information about an additional segment of background noise in the audio signal of the VoIP communication; and
adapting, responsive to receiving the additional segment information and based on the additional segment information, the history of information about background noise of the VoIP communication.

17. A method implemented at least in part by a computing device comprising:
receiving a frequency template and an excitation template representing a history of information about background noise of a Voice-over-Internet-Protocol (VoIP) communication, the frequency template and the excitation template based at least in part on a segment of background noise received as part of the VoIP communication;
generating, based on the frequency template and the excitation template, comfort noise for rendering after the first-mentioned segment of background noise;
receiving an update to the frequency template or the excitation template based at least in part on another segment of background noise, the other segment of background noise received as part of the VoIP communication after receipt of the first-mentioned segment of background noise; and
generating, based on the update and adapted to the other segment of background noise, other comfort noise for rendering after the other segment of background noise.

18. The method of claim 17, wherein the act of generating other comfort noise modifies the frequency template to reduce a frequency variance in the frequency template.

19. The method of claim 17, wherein the act of generating first-mentioned comfort noise generates first-mentioned comfort noise for a period of time and reduces the amplitude of the excitation of the first-mentioned comfort noise over the period of time.

20. The method of claim 17, wherein the acts of converting the frequency template from an LSP to a Linear Predictive Coding (LPC), randomizes the order and signs of excitation values of the excitation template to provide a randomized excitation template, and passes the randomized excitation template through the LPC synthesis filter.
